(19) United States
(12) Patent Application Publication
(10) Pub. No.: US 2015/0040906 A1
(43) Pub. Date: Feb. 12, 2015

(54) DEMAND PNEUMATIC EMERGENCY OXYGEN SYSTEM

(71) Applicant: Hans Irr, Bethlehem, PA (US)

(72) Inventor: Hans Irr, Bethlehem, PA (US)

(21) Appl. No.: 14/249,956

(22) Filed: Apr. 10, 2014

Related U.S. Application Data
(63) Continuation-in-part of application No. 29/451,916, filed on Apr. 10, 2013.
(60) Provisional application No. 61/810,455, filed on Apr. 10, 2013.

(51) Int. Cl. A62B 9/02; A62B 7/14; A62B 18/02

(52) U.S. Cl. CPC A62B 9/02; A62B 18/02; A62B 7/14
USPC 128/205.24

(57) ABSTRACT

A valve, fitting with a conventional aircraft passenger emergency mask, for controlling gas flow to a passenger emergency mask, has a housing including a gas intake portion, an intermediate portion, and a gas outlet portion; a movable valve stem between the intake and intermediate portions; a spring biasing the stem towards the closed position; with the outlet portion having a planar exterior surface with a gas outlet opening located therein

### CROSS-REFERENCE TO RELATED PATENT APPLICATIONS

This patent application claims the benefit of the 10 Apr. 2013 filing date of U.S. provisional application 61/810,459 entitled “Emergency Demand Pneumatic Oxygen System.” This priority is claimed under 35 USC 119 and 35 USC 120.

This patent application is a 35 USC 120 continuation-in-part of U.S. design patent application Ser. No. 29/451,916 filed 10 Apr. 2013 and entitled “Demand Pneumatic Oxygen System Capsule.”

The disclosures of the '459 and '916 applications are hereby incorporated by reference in their entireties.

### BACKGROUND OF THE INVENTION

1. Field of the Invention

This invention relates to systems for supplying oxygen to individuals in emergency situations, such as when a commercial airliner has a mechanical malfunction and/or is involved in a crash.

2. Description of the Prior Art

Personal oxygen masks and oxygen supply systems, for use in emergencies, are familiar to anyone who has ever flown on a commercial aircraft. Before every take-off, every commercial flight, everywhere in the world, has a cabin attendant demonstrate operation of the mask. Systems are provided such that upon occurrence of an emergency, a mask drops in front of the face of each passenger aboard the aircraft. As is demonstrated and instructed by the cabin attendant, passengers are instructed to initially put their own mask on by placing the mask over their nose and mouth and stretching an elastic band around the back of their head to retain the mask in place. Passengers are then instructed to assist children and elderly people in positioning their masks about their nose and mouth and securing the mask with the supplied elastic band.

While known and commercially used personal emergency oxygen supply systems have been widely accepted and successfully used in the case of airliner malfunctions or accidents, the supply of oxygen available to an emergency oxygen system in a commercial aircraft is limited. Compressed oxygen has substantial weight. There is a continuing push for decreased weight in commercial aircraft since a decrease in aircraft weight directly increases the effective efficiency of the airliner flight to the airline. Moreover, extended routes, such as over the Himalaya Mountains, create more efficient and more cost-effective flighting of commercial aircrafts, making them more economical and more cost-efficient to operate.

Despite the acceptability and effectiveness of current personal emergency oxygen supply systems, there is a continuing need for lighter weight supply systems and a need for a personal oxygen supply system that does not require electrical current in order to reduce power consumption on aircraft and increase safety. There is always the possibility of a spark; if electrical current could be eliminated as respecting emergency personal oxygen supply systems, safety would be increased.

### SUMMARY OF THE INVENTION

In one of its aspects, this invention provides valve apparatus for regulating flow of oxygen or other gas to an airline passenger's emergency gas mask, in which cessation of oxygen flow into a person's emergency oxygen mask is not necessarily dependent on positive pressure in the mask created by exhalation of the person who has donned the mask.

In another one of its aspects, this invention provides a valve adaptor for fitting with a conventional aircraft passenger emergency oxygen system that includes a mask for use by the passenger in the event of an emergency requiring the passenger to use the mask to obtain life-saving oxygen. In this manifestation of the invention, the valve of the invention includes a housing, a sensing diaphragm within the housing, with the housing having a sensing port aperture therein for exposing one side of the sensing diaphragm to ambient pressure.

A slave diaphragm is also within the housing and a slave chamber is within the housing as bounded in part by the slave diaphragm. An oxygen input port is formed in the housing, with the slave diaphragm being between the slave chamber and the oxygen input port. A first conduit within the housing has an input portion extending from the oxygen input port through the slave diaphragm and into the slave chamber.

The housing has an outlet port for flow of oxygen from the slave chamber to the mask. A second conduit within the housing has an intake end communicating with the slave chamber and an outlet end positioned in contact with a sensing diaphragm. A spring resides in the outlet port for biasing the sensing diaphragm against the second conduit outlet to close the second conduit outlet. The housing has a passageway therein for communication between one side of the sensing diaphragm and ambient atmosphere.

In another one of its aspects, this invention provides a valve adapted for fitting with a conventional aircraft passenger emergency oxygen system, where the system includes a mask for use by an aircraft passenger in the event of an emergency requiring the passenger to use the mask to obtain life-saving oxygen. In this aspect of the invention, the valve includes a housing, a sensing diaphragm within the housing, with the housing having a sensing port aperture for exposing one side of the sensing diaphragm to ambient pressure.

The valve further includes a slave diaphragm within the housing, and a slave chamber within the housing, that is bounded by in part by the slave diaphragm. An oxygen input port is formed in the housing. The slave diaphragm is between the slave chamber and the oxygen input port.

The valve further includes a first conduit within the housing extending from the oxygen input port through the slave diaphragm and into the slave chamber.

The housing further includes an outlet port for flow of oxygen from the slave chamber to the mask. A second conduit within the housing has an intake and communicates with the slave chamber; an outlet end contacts the sensing diaphragm. A spring resides in the outlet port and serves to bias the sensing diaphragm against the second conduit outlet thereby to close the second conduit outlet. The housing has a passageway therein for communication between one side of the sensing diaphragm and ambient atmosphere.

In yet another aspect of the invention, the housing has a first cylindrical portion with the outlet port located coaxially therein, a second cylindrical portion coaxially contacting and being of larger diameter than the first cylindrical portion, and a third portion contacting and being upstanding from a circular face of the second portion oppositely from the first portion, with the third portion having a first curved surface coaxially congruently joining a curved surface of the second cylindrical portion. The third portion has two parallel sides extending perpendicularly to and along the circular face of the second portion and away from extremities of the first curved surface. The third portion has a second curved surface extending perpendicularly from the circular face of the second cylindrical portion and joining the two parallel sides. The third portion further includes a planar surface parallel with the circular face of the second portion and adjoining the first and second curved surfaces and the two parallel sides.

### BRIEF DESCRIPTION OF THE DRAWINGS

FIG. 1 is an isometric view of the exterior of the emergency demand pneumatic oxygen valve portion of the system of the invention, showing top, the front, and the right side exterior of the emergency demand valve portion of the invention.

FIG. 2 is an isometric view of the exterior of the emergency demand pneumatic oxygen valve portion of the system of the invention, showing the top, the front, and the left side exterior of the emergency demand valve portion of the invention, viewed from a different angle than FIG. 1.

FIG. 3 is an isometric view of the exterior of the valve portion of the emergency demand pneumatic oxygen valve portion of the system of the invention installed in position on a conventional emergency passenger oxygen mask used in commercial aircraft.

FIG. 4 is an isometric view similar to FIG. 3 with the conventional emergency passenger oxygen mask illustrated in dotted lines.

FIG. 5 is a top view of the exterior of the valve portion of the emergency demand pneumatic oxygen valve portion of the system of the invention.

FIG. 6 is an isometric view of the valve portion of the emergency demand pneumatic oxygen valve portion of the system of the invention with internal parts shown in dotted lines.

FIG. 7 is an isometric view of the valve portion of the emergency demand pneumatic oxygen valve portion of the system of the invention that is similar to FIG. 6 with internal parts shown in dotted lines but with the view taken from the opposite side.

FIG. 8 is a dimensioned schematic top view of the emergency demand pneumatic oxygen valve portion of the system of the invention.

FIG. 9 is a dimensioned schematic side view of the emergency demand pneumatic oxygen valve portion of the system of the invention, with an extended outlet port portion illustrated.

FIG. 10 is a schematic representation showing operation of certain aspects of the emergency demand pneumatic oxygen system in accordance with the invention, with an oxygen reservoir cylinder shown and with a conventional passenger face mask shown, as illustrated in FIG. 3.

FIG. 11 is a top exterior view of the emergency demand pneumatic oxygen valve of the system of the invention similar to that of FIG. 5.

FIG. 12 is a sectional view of the emergency demand pneumatic oxygen valve portion of the system of the invention taken at and in the direction of lines and arrows 12-12 in FIG. 11.

FIG. 13 is a sectional view of the emergency demand pneumatic oxygen valve portion of the system of the invention taken at and in the direction of lines and arrows 13-13 in FIG. 11.

FIG. 14 is a side view of the conventional airline passenger emergency face mask with the emergency demand pneumatic oxygen valve of the system of the invention installed thereon.

FIG. 15 is an isometric view, similar to FIG. 3, showing a conventional airline passenger emergency face mask with the emergency demand pneumatic oxygen valve portion of the system of the invention installed thereon.

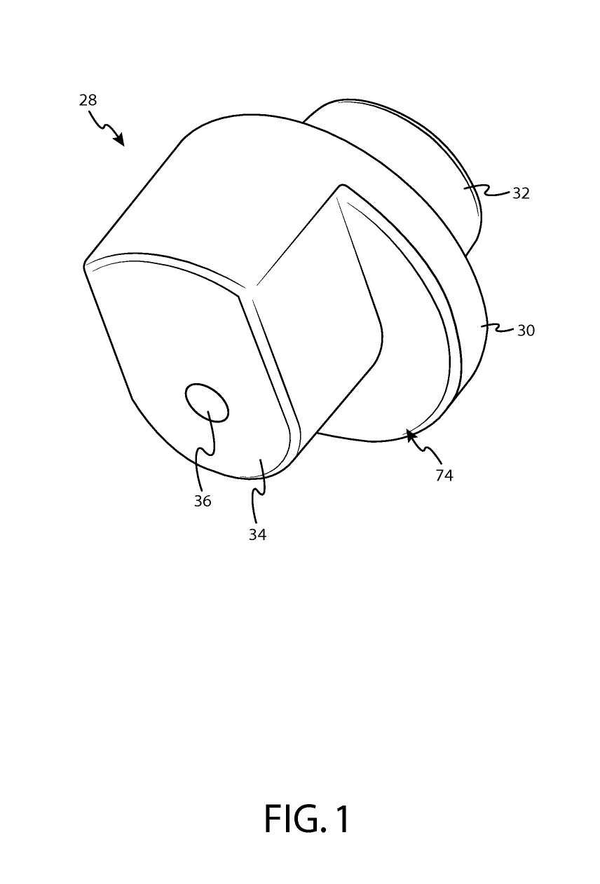

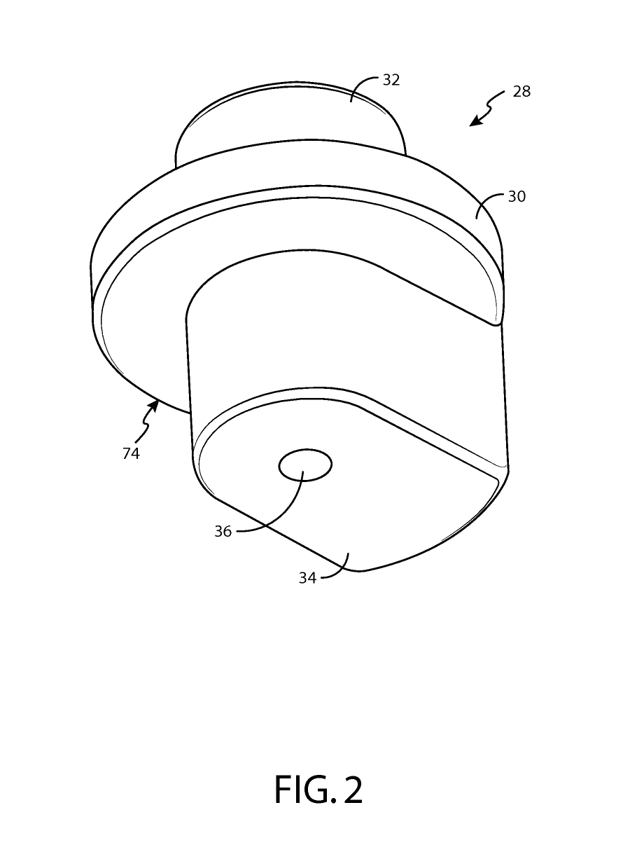

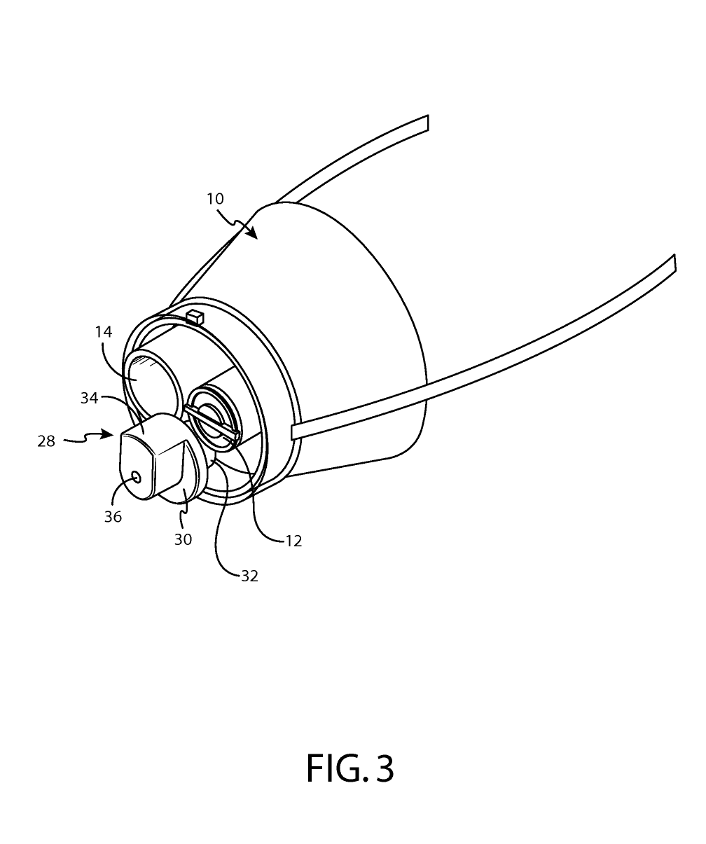

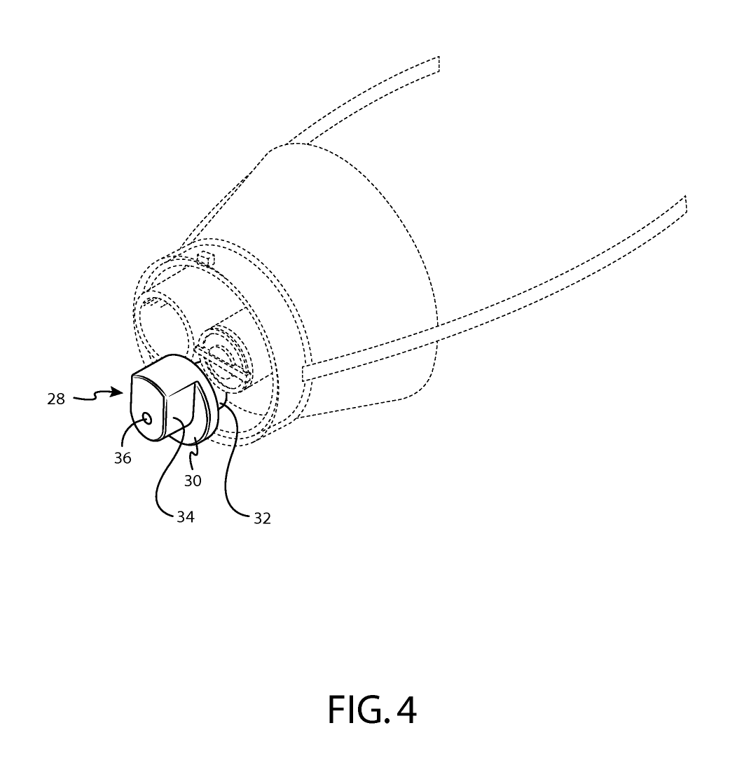

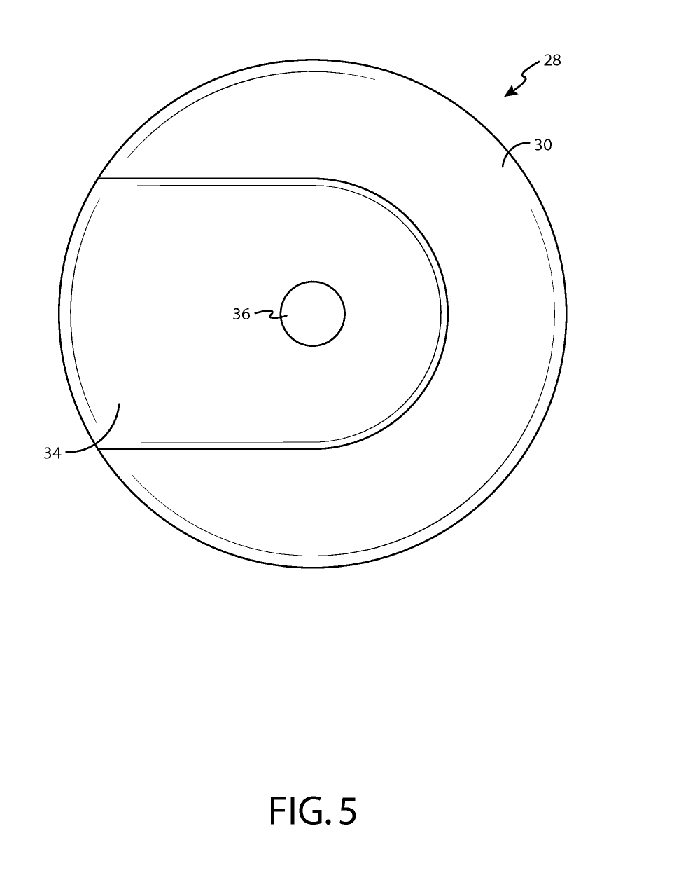

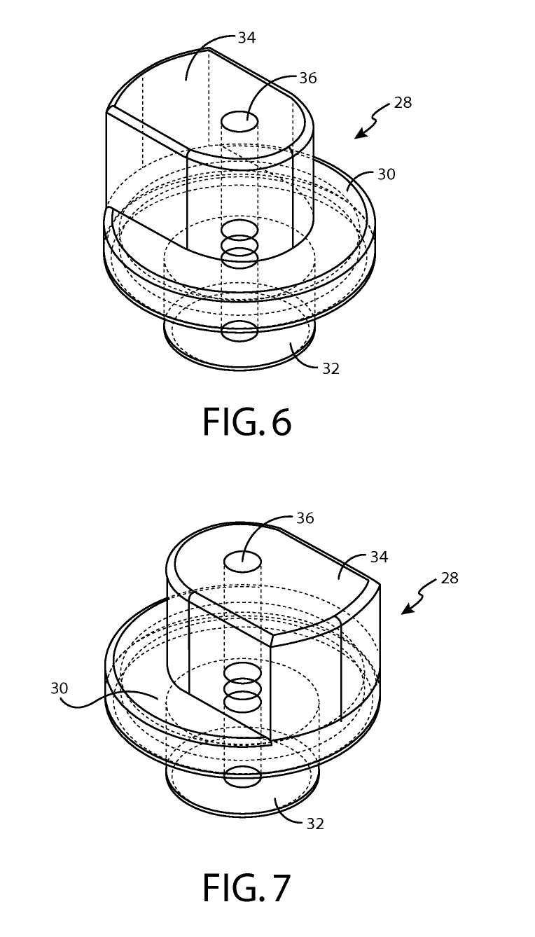

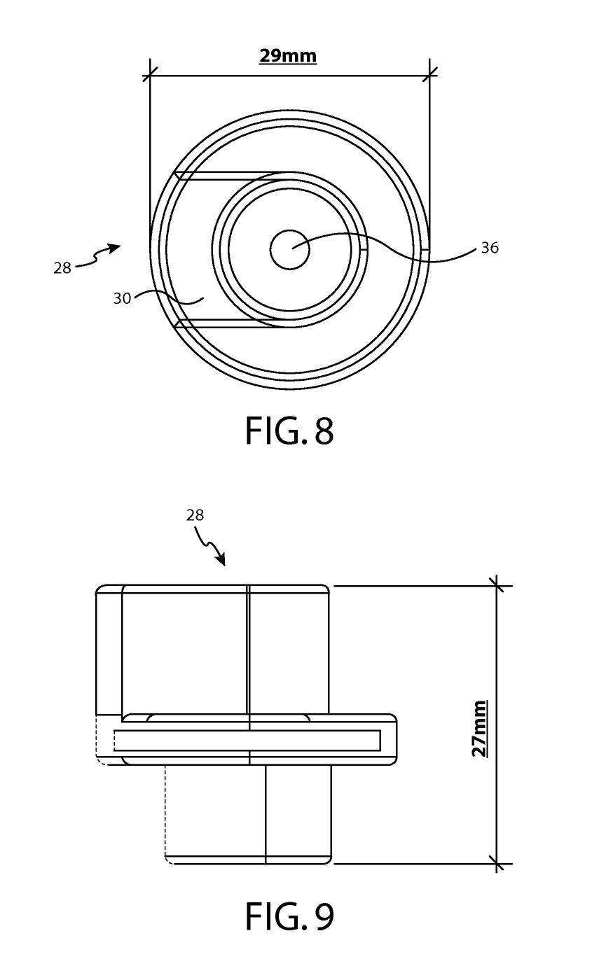

### DESCRIPTION OF THE PREFERRED EMBODIMENTS OF THE INVENTION AND THE BEST MODE KNOWN FOR PRACTICE THEREOF

This invention is used in conjunction with a conventional airline passenger emergency oxygen mask 10, inhalation valve 12 and exhalation valve 14.

In the drawings, a passenger emergency oxygen or air mask is designated generally 10 and has a mask inhalation valve designated 12 and a mask exhalation valve designated 14. An oxygen source is designated 16 and feeds oxygen via an upstream supply valve 18 into a flexible tube 20. A flow indicator 22 may be used to indicate flow in flexible tube 20. A flow controller 24 serves to regulate flow through flexible tube 20.

A demand valve 28 manifesting important parts of the invention includes a housing having a larger cylindrical portion 30, a smaller cylindrical portion 32, and a rounded cubical portion 34, where the housing as a whole is designated generally 74. Housing 74 includes an inlet aperture for demand valve 28, and a sensing spring 38 which biases a sensing diaphragm 44. An outlet port from demand valve 28 through housing 74 is designated 42 in the drawings.

A slave chamber within housing 72 is designated generally 50 and has an opening to a slave chamber feed orifice 52 and is bounded in part by slave diaphragm 54.

A main chamber 56 fills with an exhaust air or oxygen as required by the passenger. A sensing port 58 is provided in order that sensing diaphragm 44 may always have one side thereof exposed to ambient conditions.

In operation, the mask 10 is in contact with the face of a human and may or may not cover the nose as well as the mouth.

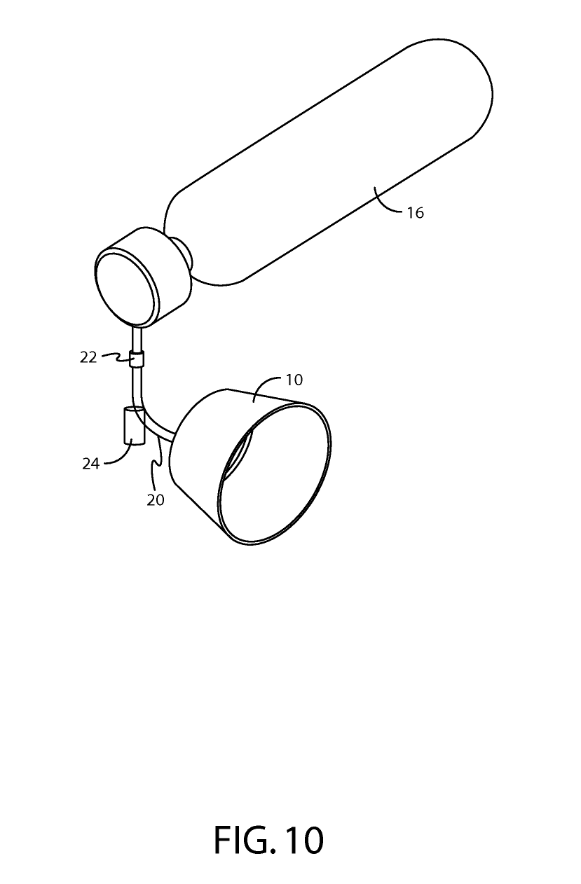

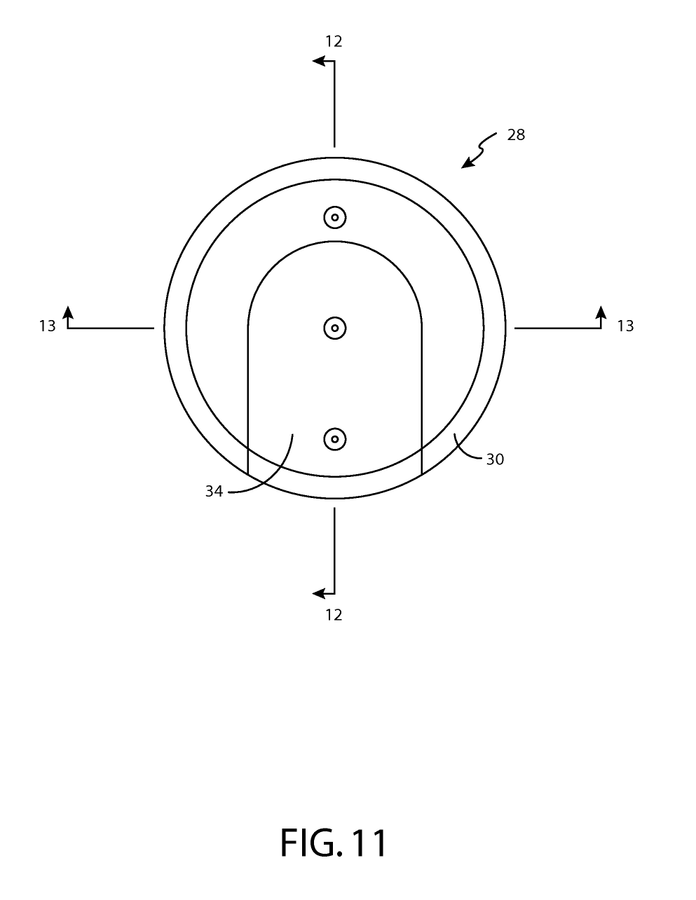

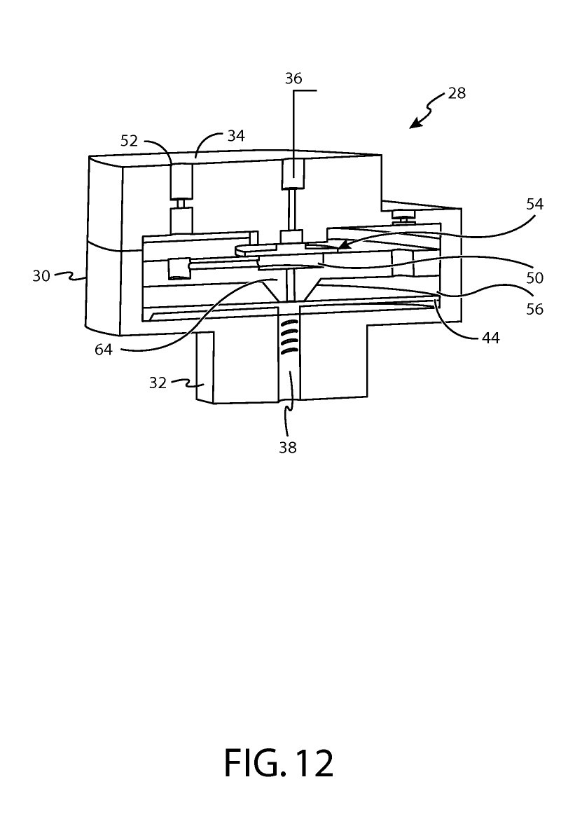

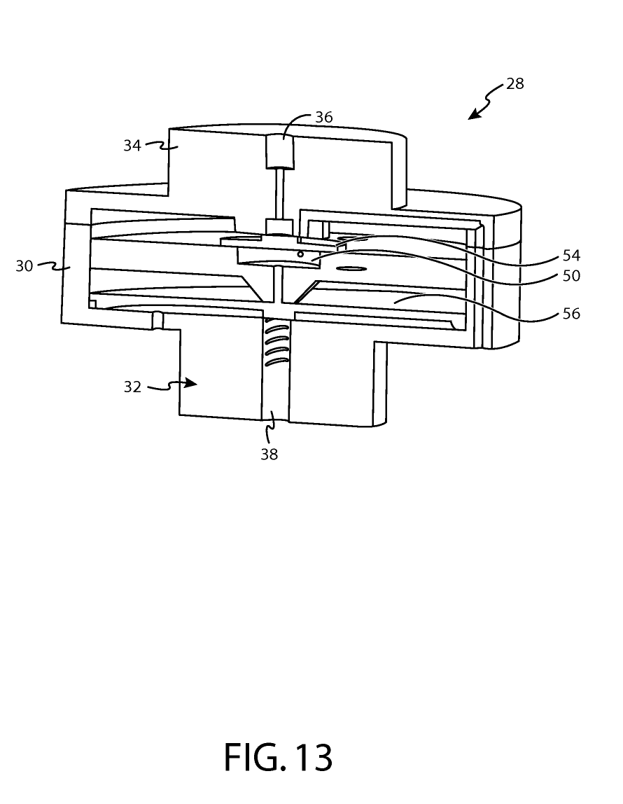

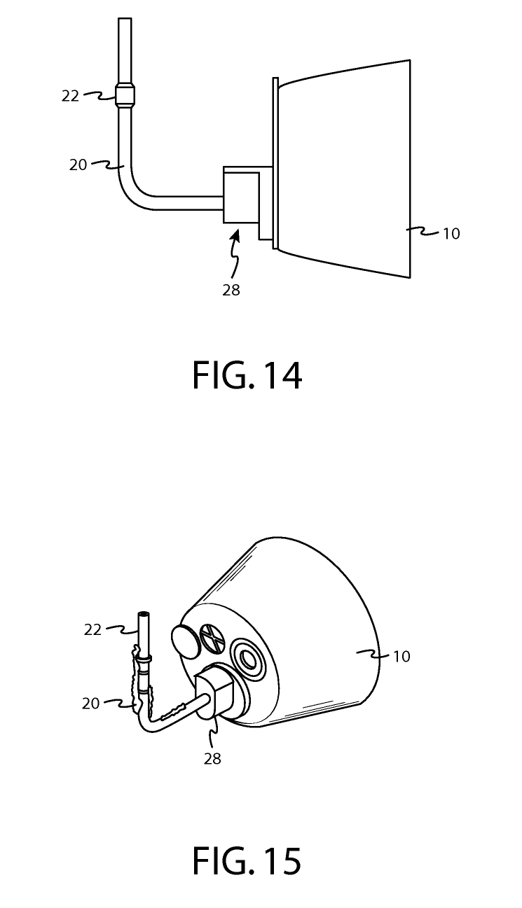

In an emergency, oxygen (or breathing air) is supplied from an oxygen source designated 16 in FIG. 10 through an upstream supply valve 16, which is a regulator or flow control valve, into one or more flexible tubes 20 each of which may contain a further flow controller 24 to limit and control flow to a demand valve 28. Tube 20 may also contain a visual or other indicator 22 to indicate gas flow.

Flexible tube 20 provides a reservoir of oxygen to supply demand valve 28. This may be augmented by an additional volume in the tube 20 between flow controller 24 and demand valve 28.

Demand valve 28 is preferably fixed to, or made part of the mask 10, or mounted close to and most preferably flushly against mask 10. Demand valve 28 could, however, be positioned anywhere between upstream supply valve 18 and mask 10. Demand valve 28 allows passage of oxygen when negative pressure is sensed as present within mask 10 at the downstream outlet of demand valve 28 during inhalation by the airline passenger. Oxygen contained in a reservoir portion of demand valve 28 then flows through the downstream outlet of demand valve 28 into mask 10. Thus a discrete volume of gas in the form of a pulse is provided by demand valve 28 into mask 10 from the reservoir portion of demand valve 28 very rapidly and well before exhalation. Flow terminates when the reservoir portion of demand valve 28 is depleted. When this occurs, demand valve 28 closes and the reservoir portion of demand valve 28 begins to refill. The volume of oxygen delivered to the airline passenger on each breath is determined by the breath frequency and as controlled by demand valve 18, flow controller 24, and the capacity of flexible tube 20 acting as a reservoir.

The negative pressure occurring when the passenger takes a breath, at which demand valve 28 is activated to produce flow of oxygen into the mask 10, is such that demand valve 28 operates before inlet valve 12 opens.

Upon exhalation by the passenger, positive pressure in mask 10 occurs, and flow from demand valve 28 has already ceased as exhalation valve 14 opens.

At higher altitudes (and hence lower ambient pressures), an altimetric sensing device can adjust the pressure and flow from valve 24 into flexible tube 20.

During operation one entire side of sensing diaphragm 44, namely the “oxygen” side 72 of sensing diaphragm 44 is always exposed to the pressure within the mask (which may be considered as the human side of the valve) via sensing port 58. The opposite side, namely the atmospheric side 70 of sensing diaphragm 44 is exposed to ambient atmosphere. There is a small central portion 60 of atmospheric side 70 of sensing diaphragm 44 that occludes an outlet of first conduit 66; the outlet is barely perceptible in the drawings and is designated 62.

Sensing diaphragm 44 is biased by a sensing spring 38 against orifice 62 and holds back oxygen from the gas supply tubing 48, illustrated in FIG. 10, which is connected to inlet aperture 36. This pressure is maintained in a small chamber 50, referred to as the “slave chamber”, which is supplied oxygen under pressure via an even smaller slave chamber feed orifice 52. Pressure in slave chamber 50 acts on slave diaphragm 54 to bias slave diaphragm 54 closed, thereby occluding second conduit 68 which serves as the outlet of the reservoir which is actually the gas supply tubing illustrated as “C” in FIG. 10. The “reservoir” is preferably filled with oxygen or air.

Sensing spring 38 is desirably, but not necessarily, secured with an adjustment screw having a center bore through to allow sensing diaphragm 44 to be exposed to the pressure in mask 10.

When the mask side (namely the passenger side) of sensing diaphragm 44 is exposed to a decrease in atmospheric pressure, which occurs when the passenger inhales, sensing diaphragm 44 overcomes force applied to it by sensing spring 38 and moves away from small orifice 62. This allows oxygen under pressure in slave chamber 50 to escape to atmosphere as the slave diaphragm 54 is biased by pressure of oxygen in the main chamber, namely in the oxygen supply tubing. This allows the oxygen in the main chamber to flow out of the main chamber and into the mask 10 via outlet port 42.

The drop in pressure required to overcome the force of the sensing spring 38 is less than the drop in pressure required to activate and open inhalation valve 12 in mask 10.

When the pressure in mask 10 to returns atmospheric or a pressure greater then atmospheric pressure, sensing diaphragm 44 is again biased closed by sensing spring 38. Oxygen that is fed by the gas supply through the small orifice into slave chamber 50 begins to fill slave chamber 50 and oxygen pressure increases in slave chamber 50. As pressure increases in slave chamber 50, slave diaphragm 54 is biased to its closed position. This allows the oxygen to accumulate into the main chamber via the flow control orifice.

Positive pressure acting on the oxygen side of sensing diaphragm 44, commonly called “back pressure”, to help bias sensing diaphragm 44 to the closed position is not necessary for demand valve 28 to function properly. Positive pressure in mask 10 does not negatively affect the performance of demand valve 28.

The foregoing description of operation of demand valve 28 is for one complete cycle or one breath by an airline passenger.

The volume of oxygen delivered into mask 10 depends on the breathing frequency of the passenger. If the passenger inhales more often, the volume of oxygen delivered to mask 10 on each cycle is smaller than if the passenger inhales less frequently. However the total volume over time, such as one minute, is consistent from minute to minute within normal human breathing rates.

In the practice of the invention, flexible tube 20 may serve as a part of the main chamber 56 of demand valve 28.

Close proximity of demand valve 28 to mask 10 reduces oxygen consumption by controlling oxygen volume downstream of valve 28, namely into mask 10, and the close proximity of valve 28 to mask 10 provides the fastest possible response for demand valve 28 upon pressure changes in mask 10, whether those pressure changes are due to the passenger's respiration or otherwise.

In accordance with the invention, altimetric pressure can be used to adjust the output pressure of oxygen from oxygen source 16 into flexible tube 20 and from there into demand valve 28.

In the invention as implemented by valve 28, cessation of oxygen flow into mask 10 is not necessarily dependent on a positive pressure in mask 10 created by exhalation of the airline passenger who has donned the mask.

In an alternative embodiment, demand valve 28 can be configured to deliver oxygen on demand during an entire period that negative pressure is sensed in mask 10 and hence can be configured to cease delivering oxygen once positive pressure is again, present and sensed within mask 10.

A major advantage of the invention is that the system is entirely pneumatic and does not require any source of electrical power for the functioning of demand valve 28 and the other components with which demand valve 28 may be used.

Demand valve 28 can be connected to or incorporated into any known conventional commercial airline or military aircraft emergency oxygen mask. Demand valve 28 need not be physically connected to the mask; any appropriate tubing leading from demand valve 28 to a mask such as mask 10 may be used.

The compact construction of demand valve 28 facilitates integration of demand valve 28 into a conventional passenger emergency oxygen mask of the type used by every airline around the world.

In operation, the invention, and specifically demand valve 28, is such that the respiration rate of the respiration of the airline passenger wearing mask 10 does not affect the consumption rate of the oxygen nor the useful life of the oxygen reservoir 26 before reservoir 26 is exhausted.

Demand valve 28 is not affected by position and can operate effectively no matter what the orientation of demand valve 28. Changes in atmospheric pressure do not adversely affect the operation or performance of demand valve 28. Demand valve 28 can also be used with standard oxygen nasal cannula, whether single or dual lumen.

1. A valve adapted for fitting with a conventional aircraft passenger emergency oxygen system that includes a mask for use by the passenger in the event of an emergency requiring the passenger to use the mask to obtain life-saving oxygen, comprising:
a) a housing;
b) a sensing diaphragm within the housing,
c) the housing having a sensing port aperture therein for exposing one side of the sensing diaphragm to ambient pressure;
d) a slave diaphragm within the housing;
e) a slave chamber within the housing and being bounded in part by the slave diaphragm;
f) an oxygen input port formed in the housing;
g) the slave diaphragm being between the slave chamber and the oxygen input port;
h) a first conduit within the housing extending from the oxygen input port through the slave diaphragm and into the slave chamber;
i) the housing having an outlet port for flow of oxygen from the slave chamber to the mask;
j) a second conduit within the housing having an intake end communicating with the slave chamber and an outlet end contacting the sensing diaphragm;
k) a spring residing in the outlet port, for biasing the sensing diaphragm against the second conduit outlet to close the conduit outlet;
l) the housing having a passageway for communication between one side of the sensing diaphragm and ambient atmosphere.

2. The valve of claim 1 wherein the housing comprises:
a) a first cylindrical portion having the outlet port coaxially located therein;
b) a second cylindrical portion coaxially contacting and being of larger diameter than the first cylindrical portion;
c) a third portion contacting and being upstanding from a circular face of the second portion oppositely from the first portion, having a first curved surface coaxially congruently joining a curved surface of the second cylindrical portion, having two parallel sides extending perpendicularly to and along the circular face of the second portion and away from extremities of said first curved surface, having a second curved surface extending perpendicularly from the circular face of the second cylindrical portion and joining the two parallel sides, and a planar surface parallel with the circular face of the second portion and joining the first and second curved surfaces and the two parallel sides.

3. A valve, fitting with a conventional aircraft passenger emergency mask, for controlling gas flow to a passenger emergency mask, comprising:
a) a housing including a gas intake portion, an intermediate portion, and a gas outlet portion;
b) a movable valve stem between the intake and intermediate portions, being movable between an open position at which the stem allows gas flow between the intake portion and the intermediate portion and a closed position at which the stem blocks gas flow between the intake and intermediate portions;
c) a spring biasing the stem towards the closed position;
d) the outlet portion having a planar exterior surface with a gas outlet opening located therein
